(19) United States
(12) Patent Application Publication
(10) Pub. No.: US 2023/0195414 A1
(43) Pub. Date: Jun. 22, 2023

(54) ARITHMETIC PROCESSING APPARATUS AND ARITHMETIC PROCESSING METHOD

(71) Applicant: Fujitsu Limited, Kawasaki-shi (JP)

(72) Inventor: Yutaka Tamiya, Yokohama (JP)

(73) Assignee: Fujitsu Limited, Kawasaki-shi (JP)

(21) Appl. No.: 17/902,129

(22) Filed: Sep. 2, 2022

(30) Foreign Application Priority Data
Dec. 16, 2021 (JP) 2021-204483

(51) Int. Cl. G06F 7/485; G06F 7/487

(52) U.S. Cl. CPC G06F 7/485; G06F 7/4873

(57) ABSTRACT

An arithmetic processing apparatus includes a processor. The processor is configured to execute a parallel calculation on a plurality of pieces of floating-point data; determine whether or not information loss is to occur in the parallel calculation; and output a result of the parallel calculation when it is determined that the information loss is not to occur, and execute a sequential calculation on the plurality of pieces of floating-point data to output the result of the sequential calculation when it is determined that the information loss is to occur.

### CROSS-REFERENCE TO RELATED APPLICATION

This application is based upon and claims the benefit of priority of the prior Japanese Patent Application No. 2021-204483, filed on Dec. 16, 2021, the entire contents of which are incorporated herein by reference.

### FIELD

The embodiments discussed herein are related to an arithmetic processing device and an arithmetic processing method.

### BACKGROUND

In high performance computing (HPC) applications, parallel computing is sometimes executed. In the parallel computing, a higher processing speed is achieved by performing a plurality of calculations in parallel.

Japanese Laid-open Patent Publication No. 2002-269066, and Japanese Laid-open Patent Publication No. 05-181645 are disclosed as related art.

Since the number of bits for expressing a floating-point value on a computer is finite, the accuracy of the result in the floating-point calculation is not guaranteed in some cases.

For example, the addition of a plurality of floating-point values mathematically has the same result regardless of the order of calculations, as in the following formula.

((a+b)+c)+d=(a+b)+(c+d)

However, in actual addition on the computer, there are cases where information loss (loss of trailing digits) happens depending on the order of calculations, and the same calculation results are not obtained.

For example, if a value having a large absolute value and a value having a small absolute value are added, the information on the value having a small absolute value is ignored. As a result, the results differ in some cases depending on the order of calculations, as indicated by the following formula.

((a+b)+c)+d≠(a+b)+(c+d)

In the parallel computing, since the order of calculations is not taken into consideration, there is a possibility that deterioration of the computation accuracy will happen due to information loss.

One aspect aims to achieve a high-speed calculation while suppressing information loss in parallel execution of floating-point calculations.

### SUMMARY

According to an aspect of the embodiments, an arithmetic processing apparatus including a memory, and a processor coupled to the memory and configured to: execute a parallel calculation on a plurality of pieces of floating-point data; determine whether or not information loss is to occur in the parallel calculation; and output a result of the parallel calculation when it is determined that the information loss is not to occur, and execute a sequential calculation on the plurality of pieces of floating-point data to output the result of the sequential calculation when it is determined that the information loss is to occur.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram schematically illustrating a hardware configuration example of an arithmetic processing device according to an embodiment;

FIG. 2 is a block diagram schematically illustrating a software configuration example of the arithmetic processing device illustrated in FIG. 1;

FIG. 3 is a diagram explaining a parallel computing process for addition in the arithmetic processing device illustrated in FIG. 1;

FIG. 4 is a diagram exemplifying a pseudocode executed by a sequential calculation unit illustrated in FIG. 2;

FIG. 5 is a block diagram schematically illustrating a software configuration example of an arithmetic processing device as a modification; and

FIG. 6 is a flowchart explaining the parallel computing process in the arithmetic processing device illustrated in FIG. 1.

### DESCRIPTION OF EMBODIMENTS

[A] Embodiment

Hereinafter, an embodiment will be described with reference to the drawings. However, the embodiment to be described below is merely an example, and there is no intention to exclude application of various modifications and techniques not explicitly described in the embodiment. For example, the present embodiment may be variously modified and carried out without departing from the spirit thereof. Furthermore, each drawing is not intended to include only components illustrated in the drawings and may include another function and the like.

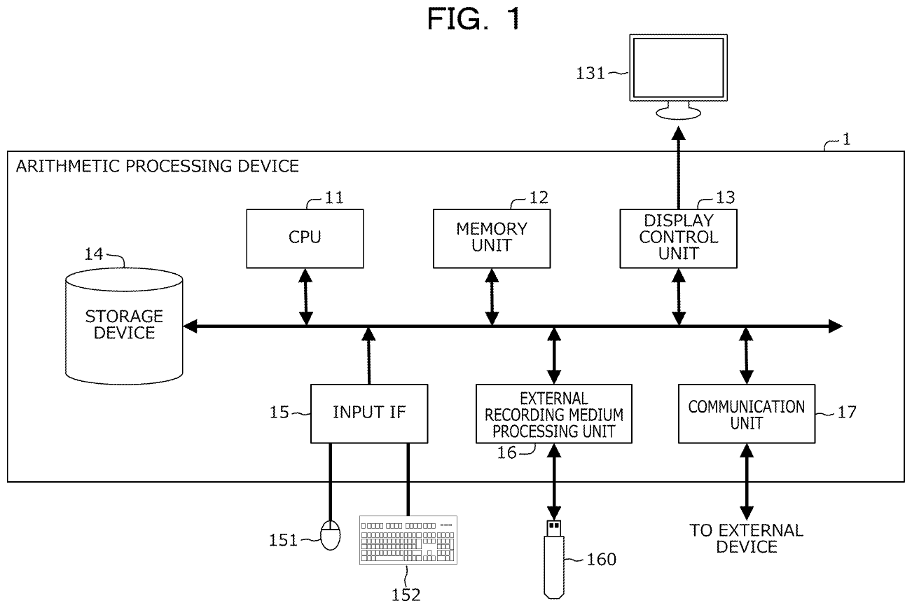

FIG. 1 is a block diagram schematically illustrating a hardware configuration example of an arithmetic processing device 1 according to the embodiment.

As illustrated in FIG. 1, the arithmetic processing device 1 is, for example, for HPC and includes a central processing unit (CPU) 11, a memory unit 12, a display control unit 13, a storage device 14, an input interface (IF) 15, an external recording medium processing unit 16, and a communication IF 17.

The memory unit 12 is an example of a storage unit and, illustratively, is a read only memory (ROM), a random access memory (RAM), or the like. Programs such as a basic input/output system (BIOS) may be written in the ROM of the memory unit 12. A software program of the memory unit 12 may be appropriately read and executed by the CPU 11. In addition, the RAM of the memory unit 12 may be used as a temporary recording memory or a working memory.

The display control unit 13 is connected to a display device 131 and controls the display device 131. The display device 131 is a liquid crystal display, an organic light-emitting diode (OLED) display, a cathode ray tube (CRT), an electronic paper display, or the like and displays various kinds of information for an operator or the like. The display device 131 may be combined with an input device and may be, for example, a touch panel.

The storage device 14 is a storage device having high input/output (IO) performance, and for example, a dynamic random access memory (DRAM), a solid state drive (SSD), a storage class memory (SCM), or a hard disk drive (HDD) may be used.

The input IF 15 may be connected to an input device such as a mouse 151 and a keyboard 152 and may control the input device such as the mouse 151 and the keyboard 152. The mouse 151 and the keyboard 152 are examples of the input devices, and the operator performs various kinds of input operations through these input devices.

The external recording medium processing unit 16 is configured in such a manner that a recording medium 160 is attachable to the external recording medium processing unit 16. The external recording medium processing unit 16 is configured in such a manner that information recorded in the recording medium 160 is allowed to be read in a state in which the recording medium 160 is attached to the external recording medium processing unit 16. In the present example, the recording medium 160 is portable. For example, the recording medium 160 is a flexible disk, an optical disc, a magnetic disk, a magneto-optical disk, a semiconductor memory, or the like.

The communication IF 17 is an interface for enabling communication with an external device.

The CPU 11 is an example of a processor and is a processing device that performs various controls and calculations. The CPU 11 implements various functions by executing an operating system (OS) or a program read into the memory unit 12. Note that the CPU 11 may be a multi-processor including a plurality of CPUs, or a multi-core processor having a plurality of CPU cores, or may have a configuration having a plurality of multi-core processors.

The device for controlling the working of the entire arithmetic processing device 1 is not limited to the CPU 11 and may be, for example, any one of an MPU, a DSP, an ASIC, a PLD, or an FPGA. In addition, the device for controlling the working of the entire arithmetic processing device 1 may be a combination of two types or more of the CPU, MPU, DSP, ASIC, PLD, or FPGA. Note that the MPU is an abbreviation for a micro processing unit, the DSP is an abbreviation for a digital signal processor, and the ASIC is an abbreviation for an application specific integrated circuit. In addition, the PLD is an abbreviation for a programmable logic device, and the FPGA is an abbreviation for a field-programmable gate array.

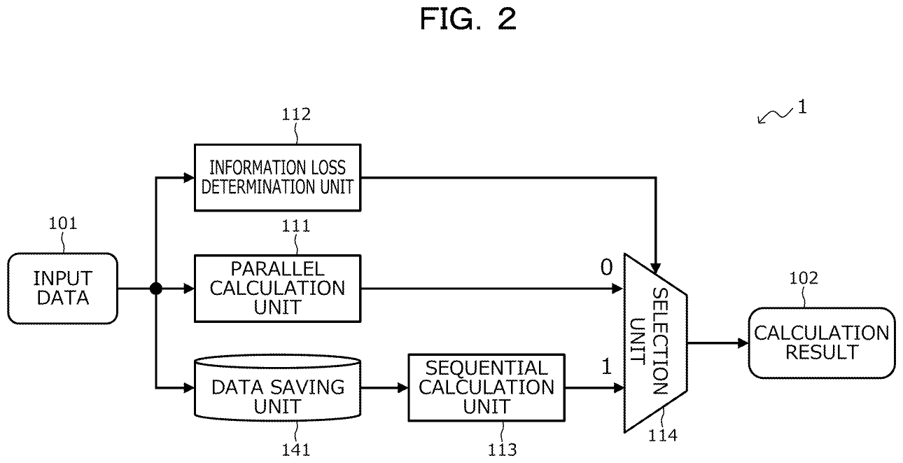

FIG. 2 is a block diagram schematically illustrating a software configuration example of the arithmetic processing device 1 illustrated in FIG. 1.

The CPU 11 of the arithmetic processing device 1 illustrated in FIG. 1 may function as a parallel calculation unit 111, an information loss determination unit 112, a sequential calculation unit 113, and a selection unit 114. In addition, one or both of the memory unit 12 and the storage device 14 of the arithmetic processing device 1 illustrated in FIG. 1 may function as a data saving unit 141.

The arithmetic processing device 1 provides an architecture that improves the efficiency of data transfer by outputting a result value obtained by conducting a calculation on input data 101, which is floating-point data, as a calculation result 102.

The parallel calculation unit 111 conducts a calculation on the input data 101 by parallelization (SIMD; single instruction/multiple data).

The information loss determination unit 112 observes the input data 101 to detect the occurrence of information loss in the parallel calculation unit 111 and controls the input of the selection unit 114.

The data saving unit 141 saves the input data 101 in case of the occurrence of information loss.

The sequential calculation unit 113 works when it is determined by the information loss determination unit 112 that information loss has occurred. The sequential calculation unit 113 executes a calculation in which no information loss happens, using all pieces of the input data 101 saved in the data saving unit 141.

Under the control of the information loss determination unit 112, the selection unit 114 selects the input “0” from the parallel calculation unit 111 when no information loss is to occur, and selects the input “1” from the sequential calculation unit 113 when the information loss has occurred, to output the selected input as the calculation result 102.

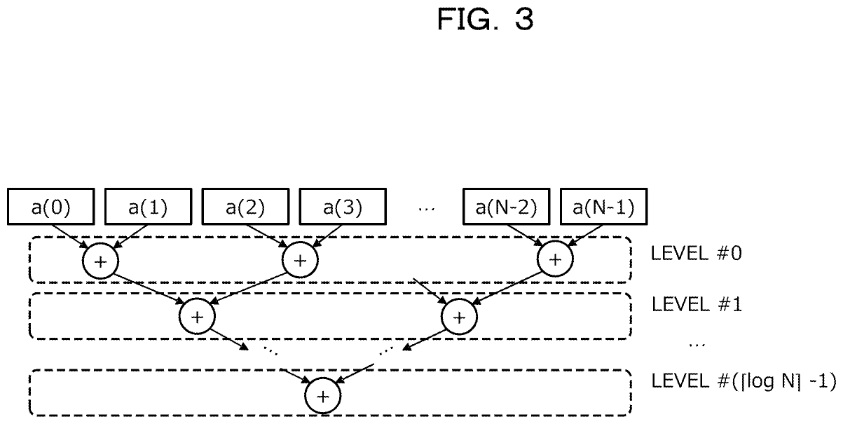

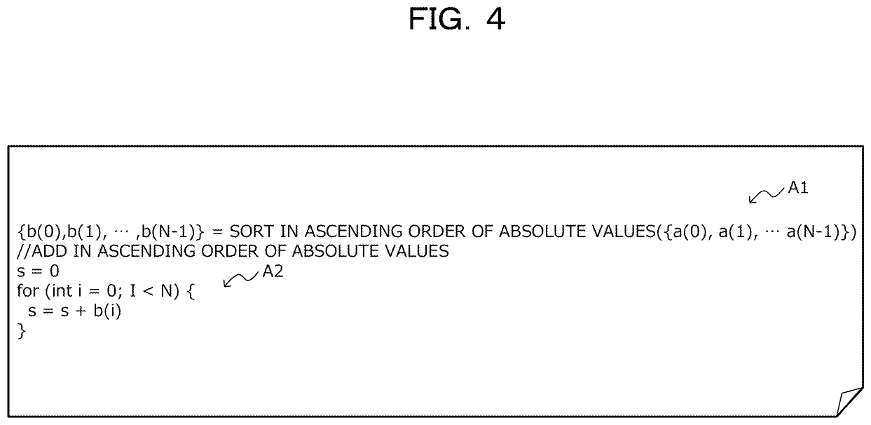

FIG. 3 is a diagram explaining a parallel computing process for addition in the arithmetic processing device 1 illustrated in FIG. 1. FIG. 4 is a diagram exemplifying a pseudocode executed by the sequential calculation unit 113 illustrated in FIG. 2.

In the example illustrated in FIG. 3,

{a(0),a(1), . . . ,a(N−1)}

is given as the input data 101, and

Σᵢ₌₀^{N-1}a(i)

is obtained as the calculation result.

As illustrated in FIG. 3, the parallel calculation unit 111 executes a binary tree type addition. The parallel calculation unit 111 speeds up the calculation processing, by performing parallel computing of additions located at the same level among Level #0, Level #1, . . . , Level #([log N]−1) in the binary tree.

For example, the parallel calculation unit 111 executes a parallel calculation on a plurality of pieces of floating-point data.

The data saving unit 141 saves

{a(0),a(1), . . . ,a(N−1)}

which represents all pieces of the input data 101, in the memory unit 12 or the like.

The information loss determination unit 112 observes the input data 101 and records the maximum value and the minimum value for the absolute values of the values of the input data 101. After finishing observing all pieces of the input data 101, the information loss determination unit 112 determines that the information loss has occurred, when the difference between the maximum value and the minimum value is equal to or higher than a predetermined threshold value. When it is determined that the information loss has occurred, the information loss determination unit 112 causes the sequential calculation unit 113 to execute a sequential calculation.

For example, the information loss determination unit 112 determines whether or not information loss is to occur in a parallel calculation. The information loss determination unit 112 may determine that information loss is to occur, when the difference between the maximum value and the minimum value among the respective absolute values of the plurality of pieces of floating-point data is equal to or higher than a first threshold value.

The information loss determination unit 112 may split the input data 101 into two groups, namely, a group equal to or higher than zero and a group lower than zero, and record the maximum values and the minimum value of each group. The information loss determination unit 112 may determine that information loss has occurred, when one or both of the difference between the maximum value and the minimum value among the absolute values of the input data equal to or higher than zero and the difference between the maximum value and the minimum value among the absolute values of the input data lower than zero are equal to or higher than a predetermined threshold value. In addition, the information loss determination unit 112 may determine that information loss has occurred, when the difference between the maximum value among the absolute values of the input data 101 equal to or higher than zero and the maximum value among the absolute values of the input data 101 lower than zero is equal to or lower than a predetermined threshold value. This may avoid the occurrence of a decrease in accuracy due to the addition of values having absolute values close to each other but with different signs.

For example, the information loss determination unit 112 may determine that information loss is to occur, when one or both of the difference between the maximum value and the minimum value among the absolute values of the data equal to or higher than zero among the plurality of pieces of floating-point data, and the difference between the maximum value and the minimum value among the absolute value of the data lower than zero among the plurality of pieces of the floating-point data are equal to or higher than a second threshold value. In addition, the information loss determination unit 112 may determine that information loss is to occur, when the difference between the maximum value among the absolute values of the data equal to or higher than zero among the plurality of pieces of floating-point data and the maximum value among the absolute values of the data lower than zero among the plurality of pieces of floating-point data is equal to or lower than a third threshold value.

As illustrated in FIG. 4, the sequential calculation unit 113 sorts all pieces of the input data 101 in ascending order of absolute values (refer to the reference sign A1) and adds the input data 101 in the order of sorting (refer to the reference sign A2). The sequential calculation unit 113 may suppress information loss by adding the input data 101 in order from one having the smallest absolute value.

For example, when it is determined that information loss is to occur, the sequential calculation unit 113 executes a sequential calculation on the plurality of pieces of floating-point data. In the sequential calculation, the sequential calculation unit 113 may add data in order from one having the smallest absolute value among the plurality of pieces of floating-point data.

As the calculation result 102, the selection unit 114 outputs the result of the parallel calculation unit 111 when no information loss is determined, and outputs the result of the sequential calculation unit 113 when information loss is determined.

For example, when it is determined that no information loss is to occur, the selection unit 114 outputs the result of the parallel calculation. On the other hand, when it is determined that information loss is to occur, the selection unit 114 outputs the result of the sequential calculation.

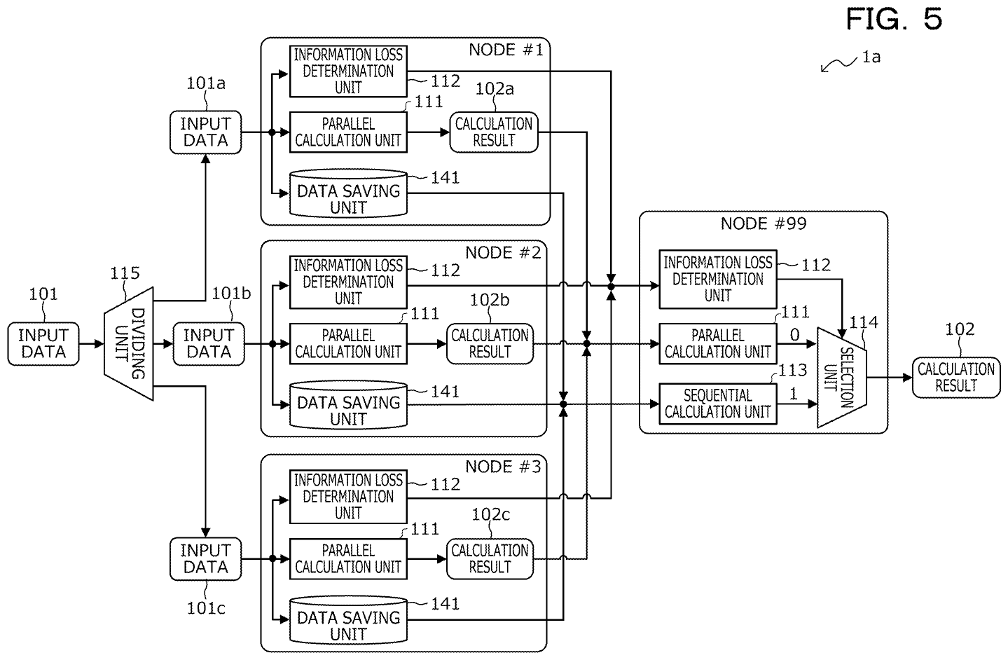

FIG. 5 is a block diagram schematically illustrating a software configuration example of an arithmetic processing device 1a as a modification.

The arithmetic processing device 1a executes a calculation using a plurality of computational nodes (nodes #1, #2, #3, and #99 in the example illustrated in FIG. 5). The arithmetic processing device 1a includes a plurality of CPUs 11 in one arithmetic processing device 1 illustrated in FIG. 1, and the plurality of CPUs 11 may individually function as each computational node. In addition, the arithmetic processing device 1a may include a plurality of arithmetic processing devices 1 illustrated in FIG. 1, and the plurality of arithmetic processing devices 1 may individually function as each computational node.

The arithmetic processing device 1a has functions as the parallel calculation unit 111, the information loss determination unit 112, and the data saving unit 141 in each of the nodes #1 to #3. In addition, the arithmetic processing device 1a has functions as the parallel calculation unit 111, the information loss determination unit 112, the sequential calculation unit 113, and the selection unit 114 in the node #99. Furthermore, the arithmetic processing device 1a has a function as a dividing unit 115 to divide the input data 101 for each of the nodes #1 to #3.

The dividing unit 115 divides the input data 101 into input data 101a, 101b, and 101c and inputs the divided input data 101a, 101b, and 101c to the nodes #1, #2, and #3, respectively.

The nodes #1 to #3 execute a parallel calculation process, a data saving process, and an information loss determination process on the input data 101a to 101c as described above with reference to FIG. 2 and the like. Then, the nodes #1 to #3 send calculation results 102a to 102c to the upper node #99. At the same time, the information loss determination units 112 of the nodes #1 to #3 observe the input data 101a to 101c and send the maximum values and the minimum values among the absolute values, to the upper node #99.

In the upper node #99, the parallel calculation unit 111 executes a parallel calculation on the calculation results 102a to 102c of the respective lower nodes #1 to #3. At the same time, the information loss determination unit 112 of the node #99 computes the maximum value and the minimum value among the absolute values in all pieces of the input data 101a to 101c, based on information loss determination results of the lower nodes #1 to #3, and determines whether or not information loss has occurred in the entire calculation process in the multiple nodes.

When no information loss has occurred, the selection unit 114 of the upper node #99 selects the result of the parallel calculation and outputs the selected result as the calculation result 102. On the other hand, when information loss has occurred, the selection unit 114 collects the input data 101a to 101c from the data saving units 141 of the lower nodes #1 to #3 to execute the sequential calculation unit 113, and selects the result of the sequential calculation to output the selected result as the calculation result 102.

For example, each of the plurality of lower nodes executes a parallel calculation on the divided data obtained by dividing the plurality of pieces of floating-point data and determines whether or not information loss has occurred. The upper node executes a parallel calculation based on each of the results of the parallel calculations in the plurality of lower nodes. The upper node determines whether or not information loss is to occur in the upper node and the plurality of lower nodes as a whole, based on the determination in the plurality of lower nodes as to whether or not information loss is to occur. The upper node outputs the result of the parallel calculation in the upper node when it is determined in the upper node that no information loss is to occur, and executes a sequential calculation on the divided data to output the result of the sequential calculation when it is determined in the upper node that information loss is to occur.

Note that, in the arithmetic processing device 1a illustrated in FIG. 5, the number of lower nodes is assumed as three, but the number of lower nodes is not limited to this. The number of lower nodes may be two or four or more.

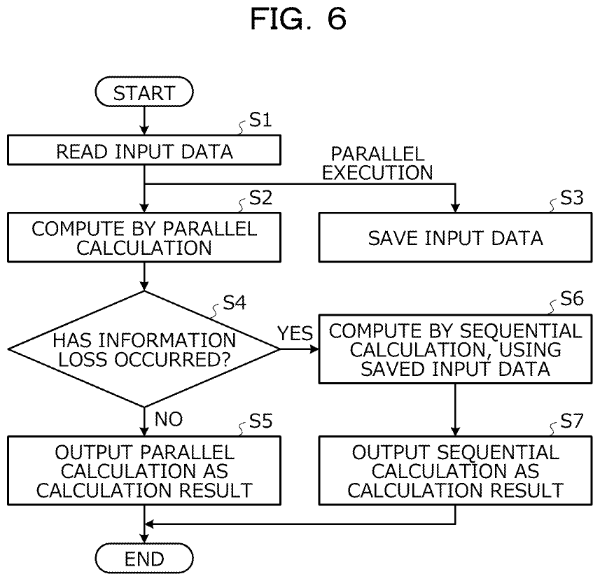

The parallel computing process in the arithmetic processing device 1 illustrated in FIG. 1 will be described with reference to the flowchart (steps S1 to S7) illustrated in FIG. 6.

The parallel calculation unit 111 reads the input data 101 (step S1).

The parallel calculation unit 111 executes a computation on the input data 101 by the parallel calculation (step S2).

The data saving unit 141 saves the input data 101 in the memory unit 12 or the like by the parallel execution with the parallel calculation in step S2 (step S3).

The information loss determination unit 112 determines whether or not information loss has occurred (step S4).

When no information loss has occurred (refer to the NO route in step S4), the selection unit 114 outputs the result of the parallel calculation as the calculation result 102 (step S5). Then, the parallel computing process ends.

On the other hand, when information loss has occurred (refer to the YES route in step S4), the sequential calculation unit 113 executes a computation on the input data 101 by the sequential calculation, using the data saved in the data saving unit 141 (step S6).

The selection unit 114 outputs the result of the sequential calculation as the calculation result 102 (step S7). Then, the parallel computing process ends.

[B] Effects

According to the arithmetic processing device 1 and the arithmetic processing method in the embodiment described above, for example, the following action effects may be obtained.

The parallel calculation unit 111 executes a parallel calculation on a plurality of pieces of floating-point data. The information loss determination unit 112 determines whether or not information loss is to occur in the parallel calculation. When it is determined that no information loss is to occur, the selection unit 114 outputs the result of the parallel calculation. On the other hand, when it is determined that information loss is to occur, the sequential calculation unit 113 executes a sequential calculation on the plurality of pieces of floating-point data, and the selection unit 114 outputs the result of the sequential calculation.

This may achieve a high-speed calculation in parallel execution of floating-point calculations, while suppressing information loss. For example, when information loss has occurred, the parallel calculation result is discarded, and the sequential calculation result is used instead, such that the calculation accuracy is not impaired. In addition, if the probability of occurrence of information loss is low, the calculation speed in the embodiment will be substantially the same as the traditional parallel calculation. Note that the time taken for determining the occurrence of information loss is smaller than the time taken for parallel calculation.

The information loss determination unit 112 determines that information loss is to occur, when the difference between the maximum value and the minimum value among the respective absolute values of the plurality of pieces of floating-point data is equal to or higher than the first threshold value. This allows the determination on the occurrence of information loss to be carried out precisely and may enhance the reliability of the arithmetic processing device 1. Note that the computation for working out the maximum value and the minimum value among the absolute values can be executed in the same computing order as the addition.

The information loss determination unit 112 determines that information loss is to occur, when one or both of the difference between the maximum value and the minimum value among the absolute values of the data equal to or higher than zero among the plurality of pieces of floating-point data, and the difference between the maximum value and the minimum value among the absolute values of the data lower than zero among the plurality of pieces of the floating-point data are equal to or higher than the second threshold value. This allows the determination on the occurrence of information loss to be carried out more precisely and may further enhance the reliability of the arithmetic processing device 1.

The information loss determination unit 112 determines that information loss is to occur, when the difference between the maximum value among the absolute values of the data equal to or higher than zero among the plurality of pieces of floating-point data and the maximum value among the absolute values of the data lower than zero among the plurality of pieces of floating-point data is equal to or lower than the third threshold value. This may suppress the occurrence of a decrease in accuracy due to the addition of values having absolute values close to each other but with different signs and may further enhance the reliability of the arithmetic processing device 1.

In the sequential calculation, the sequential calculation unit 113 adds data in order from one having the smallest absolute value among the plurality of pieces of floating-point data. This may achieve a high-speed calculation in parallel execution of floating-point calculations relating to addition, while suppressing information loss.

Each of the plurality of lower nodes executes a parallel calculation on the divided data obtained by dividing the plurality of pieces of floating-point data and determines whether or not information loss has occurred. The upper node executes a parallel calculation based on each of the results of the parallel calculations in the plurality of lower nodes. The upper node determines whether or not information loss is to occur in the upper node and the plurality of lower nodes as a whole, based on the determination in the plurality of lower nodes as to whether or not information loss is to occur. The upper node outputs the result of the parallel calculation in the upper node when it is determined in the upper node that no information loss is to occur, and executes a sequential calculation on the divided data to output the result of the sequential calculation when it is determined in the upper node that information loss is to occur. This may achieve a high-speed calculation in parallel execution of floating-point calculations for calculations distributed to a plurality of nodes, while suppressing information loss.

[C] Others

The disclosed technique is not limited to the embodiments described above, and various modifications may be made and carried out without departing from the spirit of the present embodiments. Each configuration and each process of the present embodiments may be selected or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An arithmetic processing apparatus comprising:
a memory, and
a processor coupled to the memory and configured to:
execute a parallel calculation on a plurality of pieces of floating-point data;
determine whether or not information loss is to occur in the parallel calculation; and
output a result of the parallel calculation when it is determined that the information loss is not to occur, and execute a sequential calculation on the plurality of pieces of floating-point data to output the result of the sequential calculation when it is determined that the information loss is to occur.

2. The arithmetic processing apparatus according to claim 1, wherein the processor is configured to determine that the information loss is to occur, when a difference between a maximum value and a minimum value among respective absolute values of the plurality of pieces of floating-point data is equal to or higher than a first threshold value.

3. The arithmetic processing apparatus according to claim 1, wherein the processor is configured to determine that the information loss is to occur, when one or both of a difference between a maximum value and a minimum value among absolute values of data equal to or higher than zero among the plurality of pieces of floating-point data, and the difference between the maximum value and the minimum value among the absolute values of the data lower than zero among the plurality of pieces of the floating-point data are equal to or higher than a second threshold value.

4. The arithmetic processing device according to claim 1, wherein the processor is configured to determine that the information loss is to occur, when a difference between a maximum value among absolute values of data equal to or higher than zero among the plurality of pieces of floating-point data and the maximum value among the absolute values of the data lower than zero among the plurality of pieces of floating-point data is equal to or lower than a third threshold value.

5. The arithmetic processing device according to claim 1, wherein the processor is further configured to add, in the sequential calculation, data in order from one that has a smallest absolute value among the plurality of pieces of floating-point data.

6. The arithmetic processing device according to claim 1, wherein the processor is configured to function as an upper node and a plurality of lower nodes,
each of the plurality of lower nodes executes the parallel calculation on divided data obtained by dividing the plurality of pieces of floating-point data, and determines whether or not the information loss has occurred, and
the upper node:
executes the parallel calculation, based on each result of the parallel calculation in the plurality of lower nodes;
determines whether or not the information loss is to occur in the upper node and the plurality of lower nodes as a whole, based on determination in the plurality of lower nodes as to whether or not the information loss is to occur; and
outputs the result of the parallel calculation in the upper node when it is determined in the upper node that the information loss is not to occur, and executes the sequential calculation on the divided data to output the result of the sequential calculation when it is determined in the upper node that the information loss is to occur.

7. An arithmetic processing method performed by a computer, the method comprising:
executing a parallel calculation on a plurality of pieces of floating-point data;
determining whether or not information loss is to occur in the parallel calculation; and
outputting a result of the parallel calculation when it is determined that the information loss is not to occur, and executing a sequential calculation on the plurality of pieces of floating-point data to output the result of the sequential calculation when it is determined that the information loss is to occur.

8. The arithmetic processing method according to claim 7, wherein in the determining, determining that the information loss is to occur, when a difference between a maximum value and a minimum value among respective absolute values of the plurality of pieces of floating-point data is equal to or higher than a first threshold value.

9. The arithmetic processing method according to claim 7, wherein in the determining, determining that the information loss is to occur, when one or both of a difference between a maximum value and a minimum value among absolute values of data equal to or higher than zero among the plurality of pieces of floating-point data, and the difference between the maximum value and the minimum value among the absolute values of the data lower than zero among the plurality of pieces of the floating-point data are equal to or higher than a second threshold value.

10. The arithmetic processing method according to claim 7, wherein in the determining, determining that the information loss is to occur, when a difference between a maximum value among absolute values of data equal to or higher than zero among the plurality of pieces of floating-point data and the maximum value among the absolute values of the data lower than zero among the plurality of pieces of floating-point data is equal to or lower than a third threshold value.

11. The arithmetic processing method according to claim 7, wherein in the executing the sequential calculation, the computer adds data in order from one that has a smallest absolute value among the plurality of pieces of floating-point data.

12. The arithmetic processing method according to claim 7, wherein the computer is configured to function as an upper node and a plurality of lower nodes, and the method further comprising:
as each of the plurality of lower nodes, executing the parallel calculation on divided data obtained by dividing the plurality of pieces of floating-point data, and determining whether or not the information loss has occurred, and
as the upper node,
executing the parallel calculation, based on each result of the parallel calculation in the plurality of lower nodes;
determining whether or not the information loss is to occur in the upper node and the plurality of lower nodes as a whole, based on determination in the plurality of lower nodes as to whether or not the information loss is to occur; and
outputting the result of the parallel calculation in the upper node when it is determined in the upper node that the information loss is not to occur, and executing the sequential calculation on the divided data to output the result of the sequential calculation when it is determined in the upper node that the information loss is to occur.
